(19) United States
(12) Patent Application Publication
(10) Pub. No.: US 2014/0345136 A1
(43) Pub. Date: Nov. 27, 2014

(54) HEAT DISSIPATING FIN, HEAT DISSIPATING DEVICE AND METHOD OF MANUFACTURING THE SAME

(71) Applicant: COOLER MASTER DEVELOPMENT CORPORATION, New Taipei City (TW)

(72) Inventors: Chia-Yu Lin, New Taipei City (TW); Yen Tsai, New Taipei City (TW)

(21) Appl. No.: 14/453,621

(22) Filed: Aug. 7, 2014

Related U.S. Application Data
(62) Division of application No. 13/329,313, filed on Dec. 18, 2011.

(51) Int. Cl. B23P 15/26; F28F 3/00

(52) U.S. Cl. CPC B23P 15/26; F28F 3/00; B23P 2700/10
USPC 29/890.03

(57) ABSTRACT

A heat dissipating device includes a base and a plurality of heat dissipating fins. Each of the heat dissipating fins includes a heat dissipating portion, a fixing portion and an overflow-proof structure. The fixing portion is fixed in the base. The overflow-proof structure is connected between the heat dissipating portion and the fixing portion. A width of the overflow-proof structure is larger than a width of the heat dissipating portion and larger than a width of the fixing portion.

### CROSS REFERENCE TO RELATED APPLICATIONS

This is a division application of Ser. No. 13/329,313, now pending, filed on Dec. 18, 2011.

### BACKGROUND OF THE INVENTION

1. Field of the Invention

The invention relates to a heat dissipating fin, a heat dissipating device and a method of manufacturing the same and, more particularly, to a heat dissipating fin capable of preventing overflow while manufacturing a heat dissipating device.

2. Description of the Prior Art

Heat dissipating device is a significant component for electronic products. When an electronic product is operating, the current in circuit will generate unnecessary heat due to impedance. If the heat is accumulated in the electronic components of the electronic product without dissipating immediately, the electronic components may get damage due to the accumulated heat. Therefore, the performance of heat dissipating device is a significant issue for the electronic product.

Referring to FIGS. 1 and 2, FIG. 1 is a schematic diagram illustrating a flat-type heat dissipating fin 12 of the prior art, and FIG. 2 is a schematic diagram illustrating a cylinder-type heat dissipating fin 22 of the prior art. In general, a heat dissipating device is usually equipped with a flat-type heat dissipating fin 12 shown in FIG. 1 or a cylinder-type heat dissipating fin 22 shown in FIG. 2. As shown in FIGS. 1 and 2, the flat-type heat dissipating fin 12 and the cylinder-type heat dissipating fin 22 are formed with the bases 10, 20 integrally by a die casting process. Due to the requirement of mold stripping during the die casting process, the flat-type heat dissipating fin 12 or the cylinder-type heat dissipating fin 22 has a draft angle α between 2 degrees and 3 degrees so that the whole weight of the fin is heavy and the height of the fin is limited. Furthermore, the number of heat dissipating fins is reduced in the heat dissipating device due to the draft angle α so that the heat dissipating area is not enough and the heat dissipating efficiency is worse.

### SUMMARY OF THE INVENTION

The invention provides a heat dissipating fin capable of preventing overflow while manufacturing a heat dissipating device. The heat dissipating fin is formed by a forming process without the draft angle of the conventional heat dissipating fin, so as to solve the aforesaid problems.

As mentioned in the above, the invention forms the heat dissipating fin by the forming process (e.g. aluminum extrusion process, rivet forming process, etc.) first and then forms the base, which covers the fixing portion of the heat dissipating fin, by the die casting process with the melt metal material. The heat dissipating fin of the invention has the overflow-proof structure capable of preventing the melt metal material from overflowing during the die casting process so as to prevent deckle edge from being generated. Since the heat dissipating fin of the invention is formed by the forming process, the draft angle of the conventional heat dissipating fin is unnecessary for the heat dissipating fin of the invention. Therefore, the whole weight of the heat dissipating fin of the invention can be lighter and the height of the heat dissipating fin of the invention can be higher than the prior art. Furthermore, the number of heat dissipating fins of the invention can be increased in the heat dissipating device so that the heat dissipating area can be increased and the heat dissipating efficiency can be enhanced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a flat-type heat dissipating fin of the prior art.

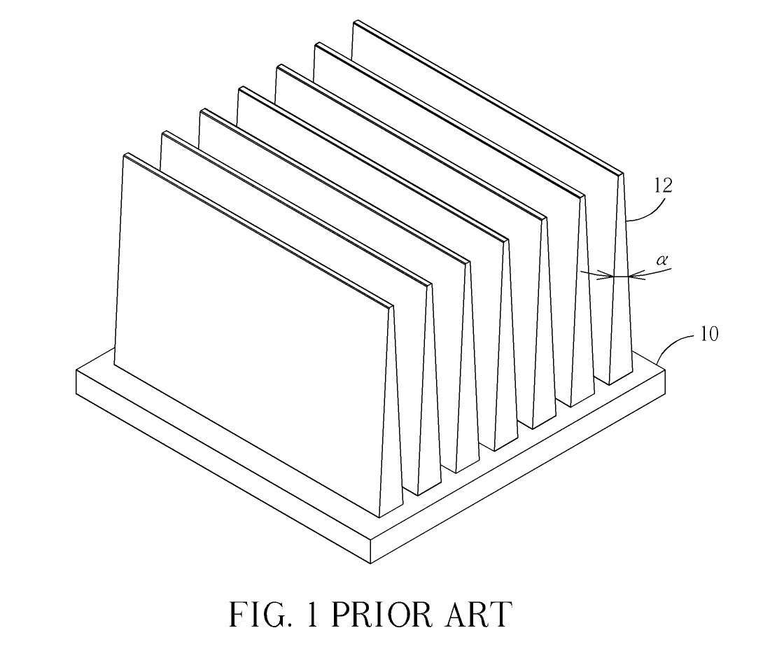

FIG. 2 is a schematic diagram illustrating a cylinder-type heat dissipating fin of the prior art.

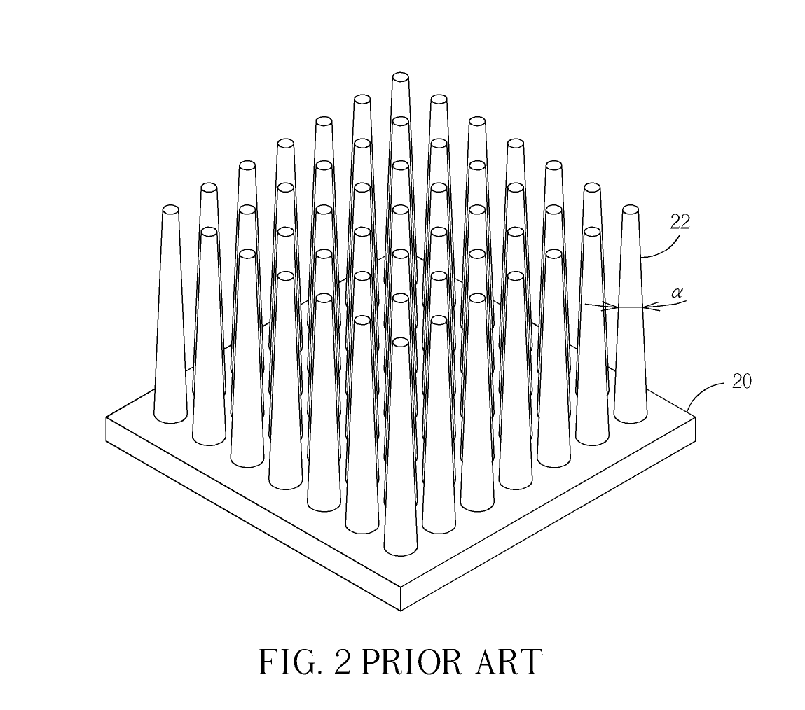

FIG. 3 is a schematic diagram illustrating a heat dissipating device according to a first embodiment of the invention.

FIG. 4 is a cross-sectional view illustrating the heat dissipating device along line A-A shown in FIG. 3.

FIG. 5 is a schematic diagram illustrating the heat dissipating fin shown in FIG. 3.

FIG. 6 is a flowchart illustrating a method of manufacturing the heat dissipating device shown in FIG. 3.

FIG. 7 is a cross-sectional view illustrating a heat dissipating fin according to a second embodiment of the invention.

FIG. 8 is a cross-sectional view illustrating a heat dissipating fin according to a third embodiment of the invention.

FIG. 9 is a cross-sectional view illustrating a heat dissipating fin according to a fourth embodiment of the invention.

FIG. 10 is a cross-sectional view illustrating a heat dissipating fin according to a fifth embodiment of the invention.

FIG. 11 is a cross-sectional view illustrating the heat dissipating device along line B-B shown in FIG. 10.

FIG. 12 is a schematic diagram illustrating the heat dissipating fin shown in FIG. 10.

FIG. 13 is a flowchart illustrating a method of manufacturing the heat dissipating device shown in FIG. 10.

FIG. 14 is a cross-sectional view illustrating a heat dissipating fin according to a sixth embodiment of the invention.

### DETAILED DESCRIPTION

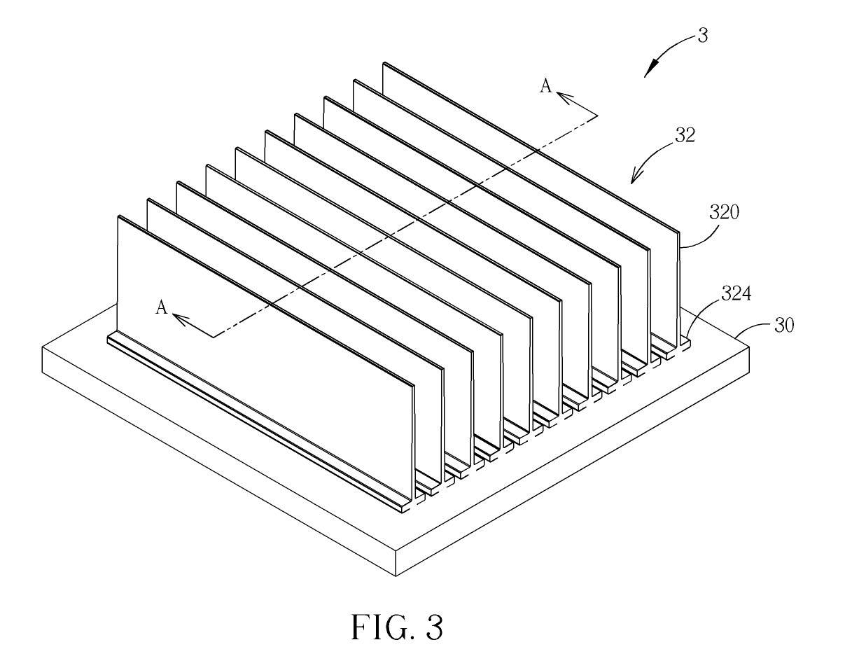

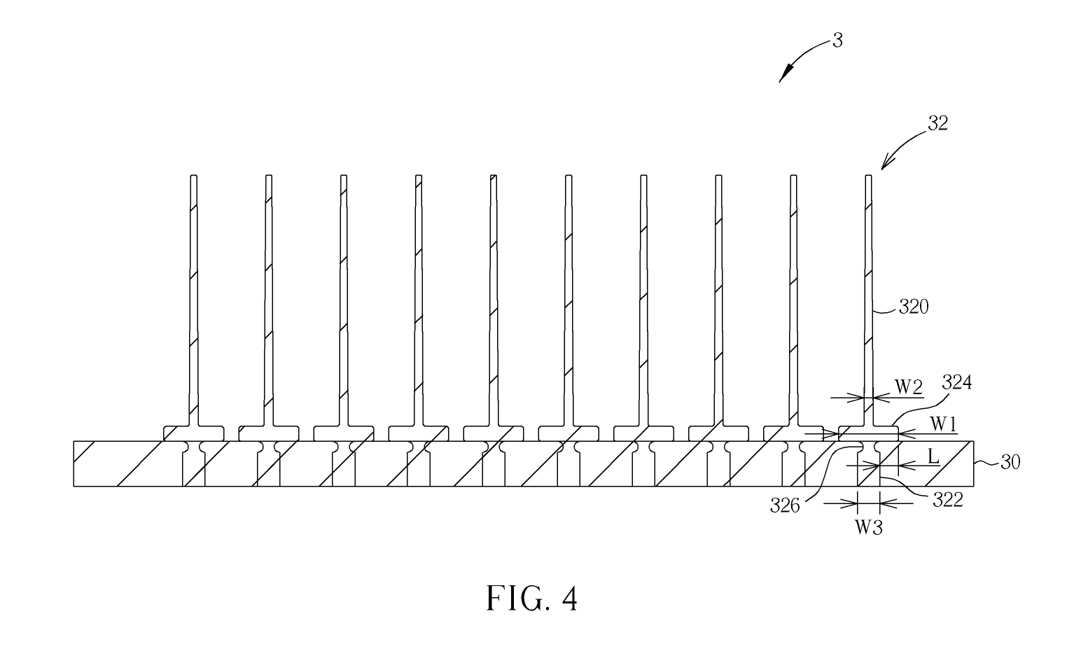

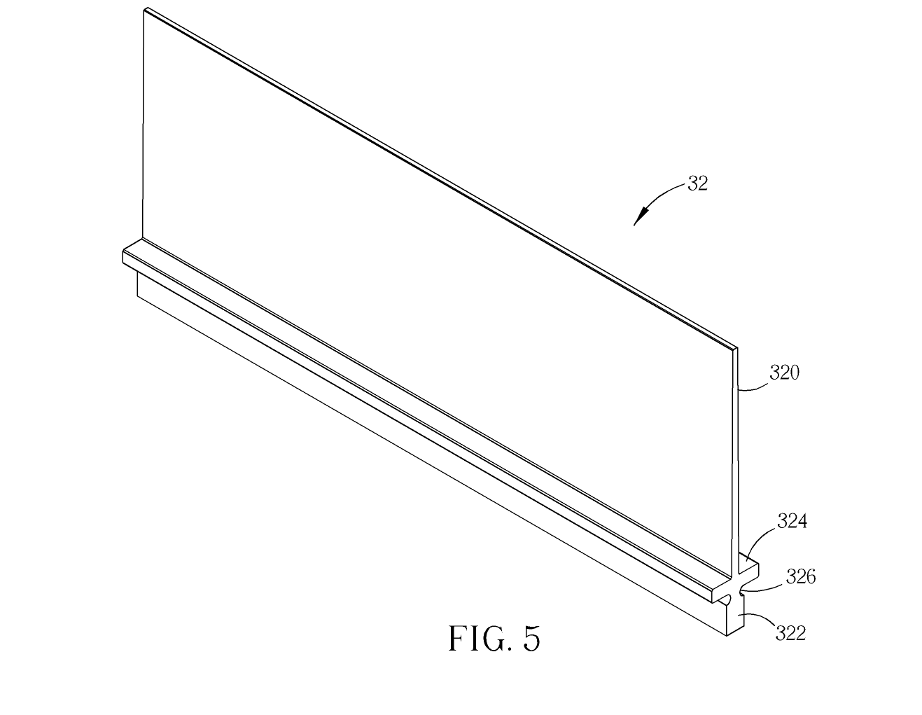

Referring to FIGS. 3 to 5, FIG. 3 is a schematic diagram illustrating a heat dissipating device 3 according to a first embodiment of the invention, FIG. 4 is a cross-sectional view illustrating the heat dissipating device 3 along line A-A shown in FIG. 3, and FIG. 5 is a schematic diagram illustrating the heat dissipating fin 32 shown in FIG. 3. As shown in FIGS. 3 and 4, the heat dissipating device 3 comprises a base 30 and a plurality of heat dissipating fins 32. As shown in FIGS. 4 and 5, each of the heat dissipating fins 32 comprises a heat dissipating portion 320, a fixing portion 322 and an overflow-proof structure 324. The fixing portion 322 is fixed in the base 30. The overflow-proof structure 324 is connected between the heat dissipating portion 320 and the fixing portion 322. A width W1 of the overflow-proof structure 324 is larger than a width W2 of the heat dissipating portion 320 and larger than a width W3 of the fixing portion 322. In this embodiment, a length L of the overflow-proof structure 324 protruded from the fixing portion 322 can be between 1 mm and 10 mm, wherein a thickness of the overflow-proof structure 324 is uniform. In another embodiment, a thickness of the overflow-proof structure 324 may vary gradiently.

Furthermore, each of the heat dissipating fins 32 may further comprise a recess structure 326 formed on the fixing portion 322. In this embodiment, the recess structure 326 is arc-shaped. In another embodiment, the recess structure 326 may be polygon-shaped.

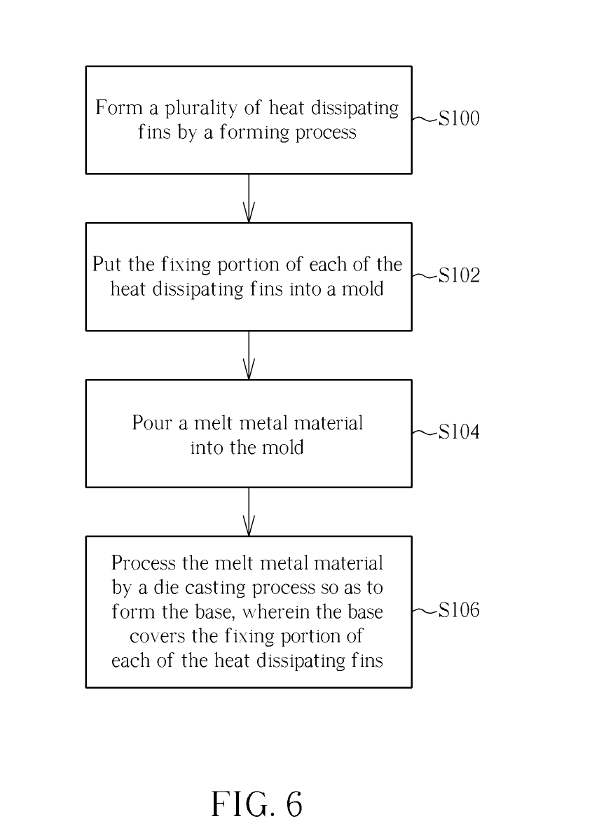

Referring to FIG. 6, FIG. 6 is a flowchart illustrating a method of manufacturing the heat dissipating device 3 shown in FIG. 3. First of all, step S100 is performed to form a plurality of heat dissipating fins 32 by a forming process. In this embodiment, the aforesaid forming process may be an aluminum extrusion process so as to form each of the heat dissipating fins 32 as a flat-type heat dissipating fin. Afterward, step S102 is performed to put the fixing portion 322 of each of the heat dissipating fins 32 into a mold (not shown). Step S104 is then performed to pour a melt metal material (e.g. aluminum, etc.) into the mold. Finally, step S106 is performed to process the melt metal material by a die casting process so as to form the base 30, wherein the base 30 covers the fixing portion 322 of each of the heat dissipating fins 32, as shown in FIG. 4. In this embodiment, the overflow-proof structure 324 of each of the heat dissipating fins 32 is capable of preventing the melt metal material from overflowing during the die casting process so as to prevent deckle edge from being generated. When the length L of the overflow-proof structure 324 protruded from the fixing portion 322 is between 1 mm and 10 mm, the overflow-proof structure 324 can prevent the melt metal material from overflowing during the die casting process effectively so as to prevent deckle edge from being generated. Furthermore, the recess structure 326 of each of the heat dissipating fins 32 can hold the metal material effectively so as to enhance the combination strength between the base 30 and the heat dissipating fins 32.

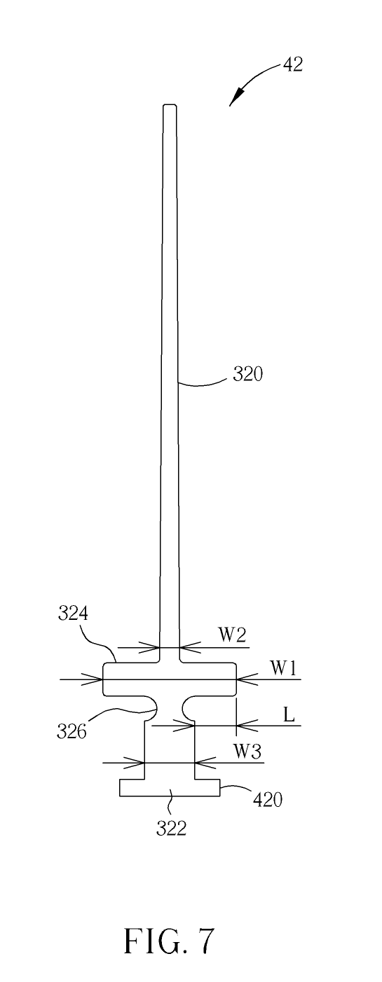

Referring to FIG. 7 along with FIG. 4, FIG. 7 is a cross-sectional view illustrating a heat dissipating fin 42 according to a second embodiment of the invention. The difference between the heat dissipating fin 42 and the aforesaid heat dissipating fin 32 is that the heat dissipating fin 42 further comprises a protruding structure 420. As shown in FIG. 7, the protruding structure 420 protrudes from one end of the fixing portion 322. When the heat dissipating fin 32 shown in FIG. 4 is replaced by the heat dissipating fin 42 shown in FIG. 7, the protruding structure 420 of the heat dissipating fin 42 can cooperate with the overflow-proof structure 324 to hold the metal material so as to enhance the combination strength between the base 30 and the heat dissipating fin 42. It should be noted that the same elements in FIG. 7 and FIG. 4 are represented by the same numerals, so the repeated explanation will not be depicted herein again. Moreover, the heat dissipating fin 42 can be also formed by the forming process of the aforesaid step S100.

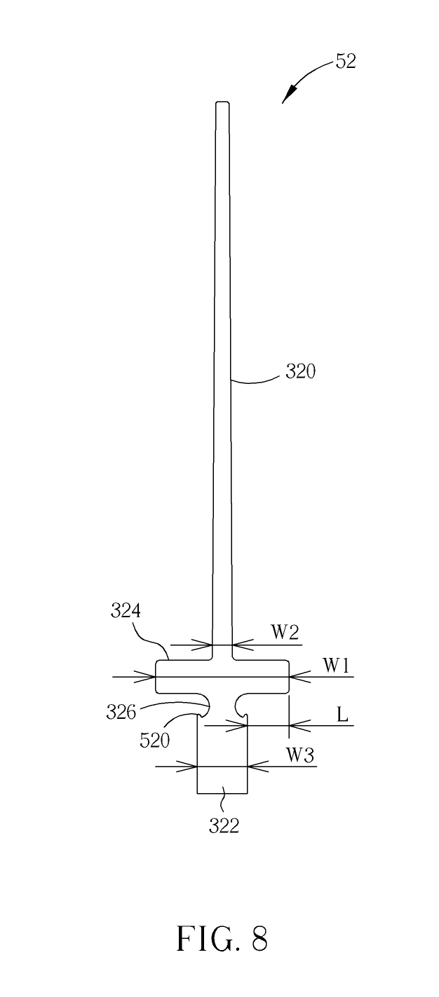

Referring to FIG. 8 along with FIG. 4, FIG. 8 is a cross-sectional view illustrating a heat dissipating fin 52 according to a third embodiment of the invention. The difference between the heat dissipating fin 52 and the aforesaid heat dissipating fin 32 is that the heat dissipating fin 52 further comprises a hook structure 520. As shown in FIG. 8, the hook structure 520 is formed in the recess structure 326. When the heat dissipating fin 32 shown in FIG. 4 is replaced by the heat dissipating fin 52 shown in FIG. 8, the hook structure 520 of the heat dissipating fin 52 can hook the metal material so as to enhance the combination strength between the base 30 and the heat dissipating fin 52. It should be noted that the same elements in FIG. 8 and FIG. 4 are represented by the same numerals, so the repeated explanation will not be depicted herein again. Moreover, the heat dissipating fin 52 can be also formed by the forming process of the aforesaid step S100.

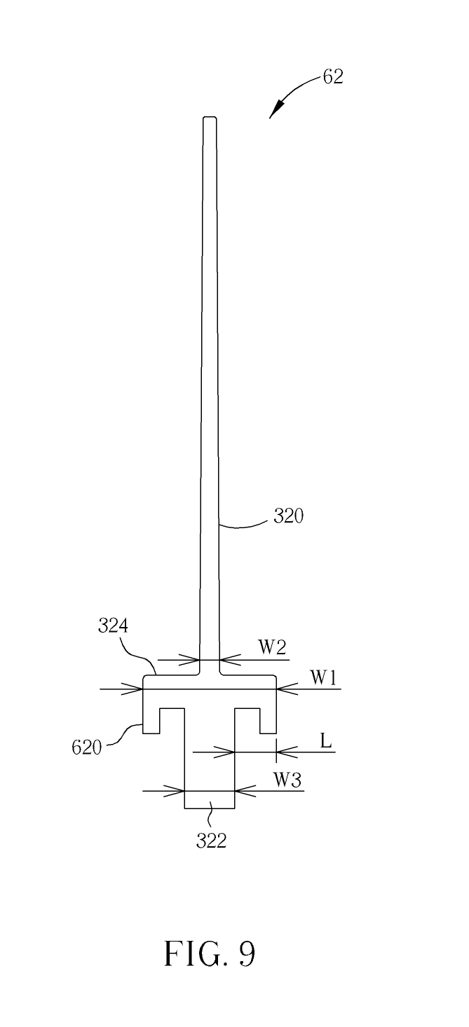

Referring to FIG. 9 along with FIG. 4, FIG. 9 is a cross-sectional view illustrating a heat dissipating fin 62 according to a fourth embodiment of the invention. The difference between the heat dissipating fin 62 and the aforesaid heat dissipating fin 32 is that the heat dissipating fin 62 further comprises an extending structure 620 and does not comprise the aforesaid recess structure 326. As shown in FIG. 9, the extending structure 620 is extended from the overflow-proof structure 324 toward the fixing portion 322, and the overflow-proof structure 324 and the extending structure 620 are formed as U-shape. When the heat dissipating fin 32 shown in FIG. 4 is replaced by the heat dissipating fin 62 shown in FIG. 9, the extending structure 620 of the heat dissipating fin 62 can cooperate with the overflow-proof structure 324 to hold the metal material so as to enhance the combination strength between the base 30 and the heat dissipating fin 62. It should be noted that the same elements in FIG. 9 and FIG. 4 are represented by the same numerals, so the repeated explanation will not be depicted herein again. Moreover, the heat dissipating fin 62 can be also formed by the forming process of the aforesaid step S100.

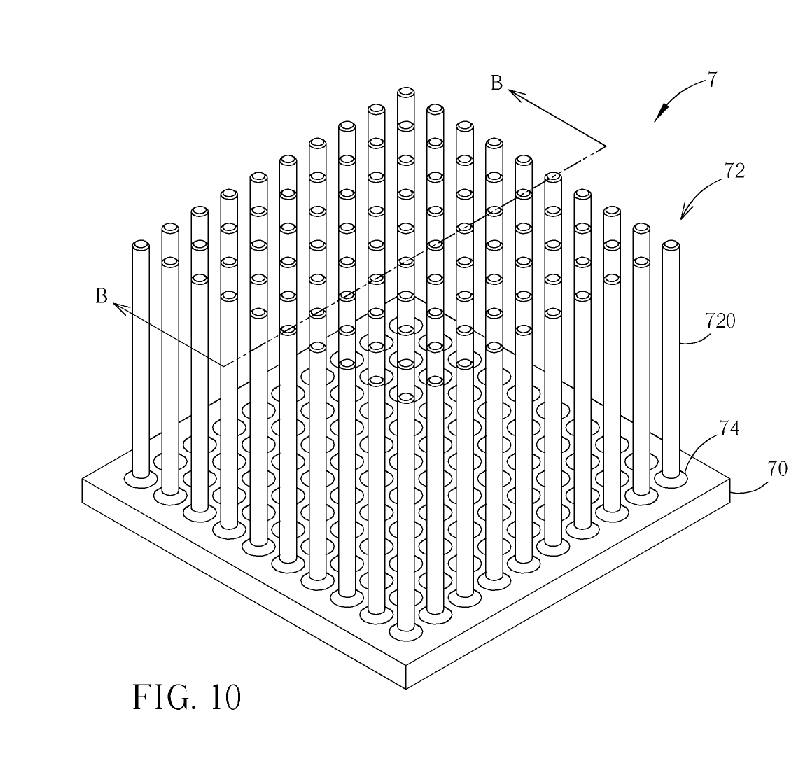

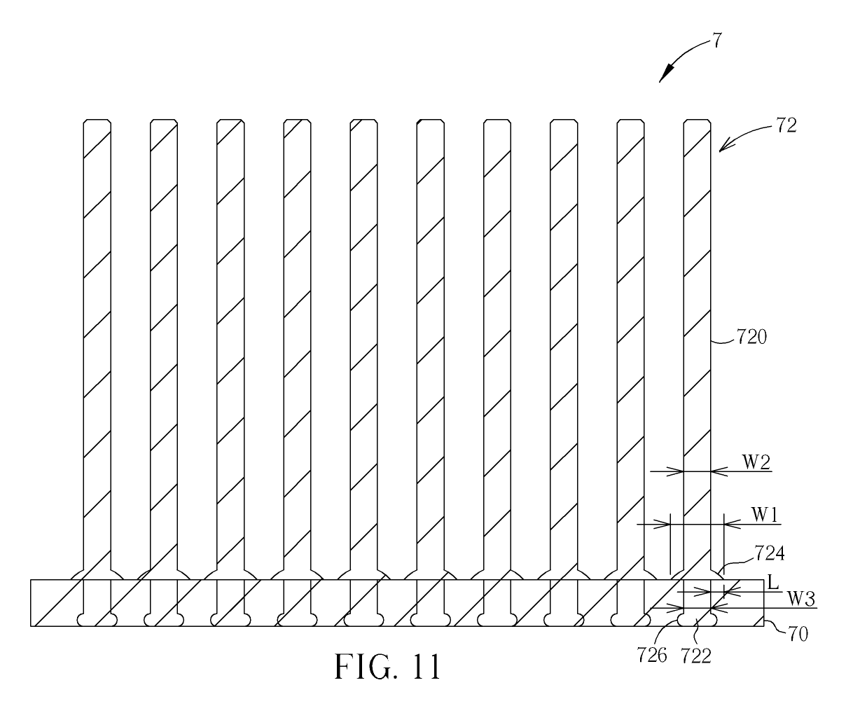

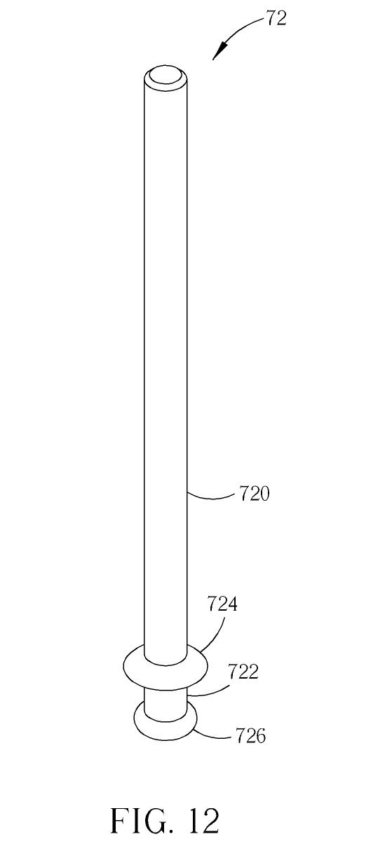

Referring to FIGS. 10 to 12, FIG. 10 is a schematic diagram illustrating a heat dissipating device 7 according to a fifth embodiment of the invention, FIG. 11 is a cross-sectional view illustrating the heat dissipating device 7 along line B-B shown in FIG. 10, and FIG. 12 is a schematic diagram illustrating the heat dissipating fin 72 shown in FIG. 10. As shown in FIGS. 10 and 11, the heat dissipating device 7 comprises a base 70 and a plurality of heat dissipating fins 72. As shown in FIGS. 11 and 12, each of the heat dissipating fins 72 comprises a heat dissipating portion 720, a fixing portion 722, an overflow-proof structure 724 and a protruding structure 726. The fixing portion 722 and the protruding structure 726 are fixed in the base 70. The overflow-proof structure 724 is connected between the heat dissipating portion 720 and the fixing portion 722. A width W1 of the overflow-proof structure 724 is larger than a width W2 of the heat dissipating portion 720 and larger than a width W3 of the fixing portion 722. In this embodiment, a length L of the overflow-proof structure 724 protruded from the fixing portion 722 can be between 1 mm and 10 mm. The protruding structure 726 protrudes from one end of the fixing portion 722. In this embodiment, a thickness of the overflow-proof structure 724 varies gradiently. In another embodiment, a thickness of the overflow-proof structure 724 may be uniform.

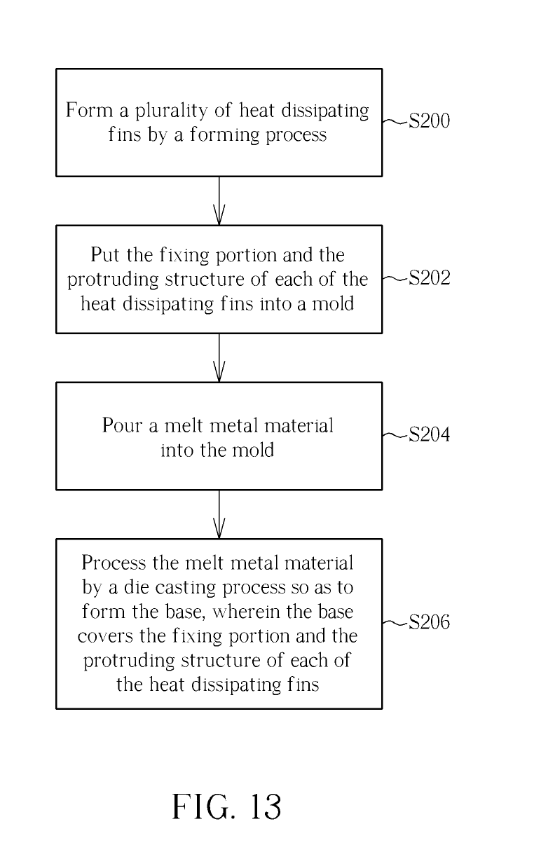

Referring to FIG. 13, FIG. 13 is a flowchart illustrating a method of manufacturing the heat dissipating device 7 shown in FIG. 10. First of all, step S200 is performed to form a plurality of heat dissipating fins 72 by a forming process. In this embodiment, the aforesaid forming process may be a rivet forming process so as to form each of the heat dissipating fins 72 as a cylinder-type heat dissipating fin. Afterward, step S202 is performed to put the fixing portion 722 and the protruding structure 726 of each of the heat dissipating fins 72 into a mold (not shown). Step S204 is then performed to pour a melt metal material (e.g. aluminum, etc.) into the mold. Finally, step S206 is performed to process the melt metal material by a die casting process so as to form the base 70, wherein the base 70 covers the fixing portion 722 and the protruding structure 726 of each of the heat dissipating fins 72, as shown in FIG. 11. In this embodiment, the overflow-proof structure 724 of each of the heat dissipating fins 72 is capable of preventing the melt metal material from overflowing during the die casting process so as to prevent deckle edge from being generated. When the length L of the overflow-proof structure 724 protruded from the fixing portion 722 is between 1 mm and 10 mm, the overflow-proof structure 724 can prevent the melt metal material from overflowing during the die casting process effectively so as to prevent deckle edge from being generated. Furthermore, the protruding structure 726 of each of the heat dissipating fins 72 can cooperate with the overflow-proof structure 724 to hold the metal material so as to enhance the combination strength between the base 70 and the heat dissipating fins 72.

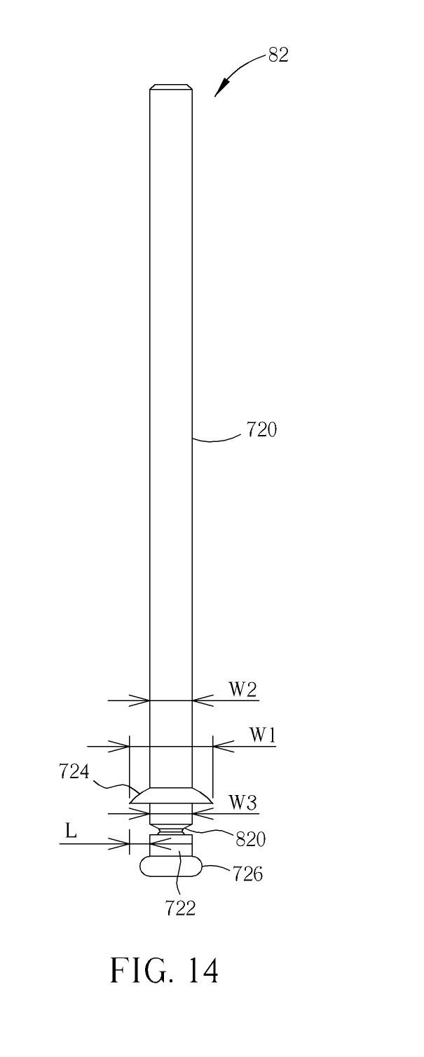

Referring to FIG. 14 along with FIG. 11, FIG. 14 is a cross-sectional view illustrating a heat dissipating fin 82 according to a sixth embodiment of the invention. The difference between the heat dissipating fin 82 and the aforesaid heat dissipating fin 72 is that the heat dissipating fin 82 further comprises a recess structure 820. As shown in FIG. 14, the recess structure 820 is formed on the fixing portion 722. When the heat dissipating fin 72 shown in FIG. 11 is replaced by the heat dissipating fin 82 shown in FIG. 14, the recess structure 820 of the heat dissipating fin 82 can hold the metal material effectively so as to enhance the combination strength between the base 70 and the heat dissipating fin 82. It should be noted that the same elements in FIG. 14 and FIG. 11 are represented by the same numerals, so the repeated explanation will not be depicted herein again. Moreover, the heat dissipating fin 82 can be also formed by the forming process of the aforesaid step S200.

As mentioned in the above, the invention forms the heat dissipating fin by the forming process (e.g. aluminum extrusion process, rivet forming process, etc.) first and then forms the base, which covers the fixing portion of the heat dissipating fin, by the die casting process with the melt metal material. The heat dissipating fin of the invention has the overflow-proof structure capable of preventing the melt metal material from overflowing during the die casting process so as to prevent deckle edge from being generated. Since the heat dissipating fin of the invention is formed by the forming process, the draft angle of the conventional heat dissipating fin is unnecessary for the heat dissipating fin of the invention. Therefore, the whole weight of the heat dissipating fin of the invention can be lighter and the height of the heat dissipating fin of the invention can be higher than the prior art. Furthermore, the number of heat dissipating fins of the invention can be increased in the heat dissipating device so that the heat dissipating area can be increased and the heat dissipating efficiency can be enhanced. Moreover, the invention may form the recess structure, the protruding structure, the hook structure and/or the extending structure on the heat dissipating fin so as to enhance the combination strength between the base and the heat dissipating fin.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of manufacturing a heat dissipating device comprising:
forming a plurality of heat dissipating fins by a forming process, wherein each of the heat dissipating fins comprises a heat dissipating portion, a fixing portion and an overflow-proof structure, the overflow-proof structure is connected between the heat dissipating portion and the fixing portion, a width of the overflow-proof structure is larger than a width of the heat dissipating portion and larger than a width of the fixing portion;
putting the fixing portion of each of the heat dissipating fins into a mold;
pouring a melt metal material into the mold; and
processing the melt metal material by a die casting process so as to form a base, wherein the base covers the fixing portion of each of the heat dissipating fins and the overflow-proof structure of each of the heat dissipating fins prevents the melt metal material from overflowing.

2. The method of claim 1, wherein the forming process is an aluminum extrusion process and each of the heat dissipating fins is a flat-type heat dissipating fin, or the forming process is a rivet forming process and each of the heat dissipating fins is a cylinder-type heat dissipating fin.

3. The method of claim 1, wherein forming a plurality of heat dissipating fins by a forming process further comprises forming a recess structure on the fixing portion.

4. The method of claim 1, wherein forming a plurality of heat dissipating fins by a forming process further comprises forming a protruding structure on the fixing portion and enabling the protruding structure to protrude from one end of the fixing portion.

5. The method of claim 1, wherein forming a plurality of heat dissipating fins by a forming process further comprises forming an extending structure on the overflow-proof structure and enabling the extending structure to extend from the overflow-proof structure toward the fixing portion.
